(19) United States
(12) Patent Application Publication
(10) Pub. No.: US 2016/0071112 A1
(43) Pub. Date: Mar. 10, 2016

(54) METHOD AND SYSTEM FOR PROVIDING TRANSPARENCY IN DATA COLLECTION AND USAGE

(71) Applicant: MasterCard International Incorporated, Purchase, NY (US)

(72) Inventor: Kenneth UNSER, Fairfield, CT (US)

(73) Assignee: MasterCard International Incorporated, Purchase, NY (US)

(21) Appl. No.: 14/482,548

(22) Filed: Sep. 10, 2014

(51) Int. Cl. G06Q 30/00; G06Q 50/26

(52) U.S. Cl. CPC G06Q 30/01; G06Q 50/265

(57) ABSTRACT

A method for providing transparency for gathered purchase data includes: storing a plurality of account profiles, each profile including data related to a transaction account associated with a consumer including an account identifier and a plurality of consumer data entries, each entry including data associated with the associated consumer including a data value; receiving a data request, the request including a specific account identifier and one or more requested consumer data entries; identifying a specific account profile where the account identifier corresponds to the specific account identifier; identifying, in the specific account profile, one or more consumer data entries corresponding to the one or more requested consumer data entries; and transmitting the data value included in each of the identified consumer data entries, wherein the data values are based on one or more payment transactions or use of a payment card associated with the related transaction account.

### FIELD

The present disclosure relates to the providing of transparency for gathered purchase data and updating thereof, specifically providing the ability for a consumer to view and manage data collected on the consumer and its uses by third parties.

### BACKGROUND

As technology continues to develop, consumers tend to use technology in more and more aspects of their daily lives. At the same time, as consumer use of technology increases, the value to third parties, such as merchants, advertisers, content providers, etc., of data regarding the consumers also increases. As a result, a vast number of methods and systems have been developed for gathering, analyzing, and using consumer data, particularly data regarding payment transactions involving a consumer.

While the gathering of data on a consumer can be useful to that consumer, such as by receiving benefits that are targeted directly to that consumer, many consumers are often concerned that the data being gathered on them may be incorrect, may be too detailed, and may not be in accord with their views regarding their own personal privacy. However, there is currently a lack of technology in the form of systems and methods to enable a consumer to effectively view and manage data that is gathered on them.

Thus, there is a need for a technical solution for providing transparency for gathered purchase data for a consumer and enabling the consumer to manage their gathered purchase data as they desire.

### SUMMARY

The present disclosure provides a description of systems and methods for providing transparency for gathered purchase data and updating and management thereof.

A method for providing transparency for gathered purchase data includes: storing, in an account database, a plurality of account profiles, wherein each account profile includes data related to a transaction account associated with a consumer including at least an account identifier and a plurality of consumer data entries, each consumer data entry including data associated with the associated consumer including a data value and at least one of: source data, use data, and permission data; receiving, by a receiving device, a data request, wherein the data request includes at least a specific account identifier and one or more requested consumer data entries; identifying, in the account database, a specific account profile where the included account identifier corresponds to the specific account identifier; identifying, in the specific account profile, one or more consumer data entries of the plurality of consumer data entries corresponding to the one or more requested consumer data entries; and transmitting, by a transmitting device, at least the data value included in each of the identified one or more consumer data entries, wherein the data value included in each consumer data entry is based on one or more payment transactions or use of a payment card associated with the related transaction account.

A method for updating gathered purchase data includes: storing, in an account database, an account profile, wherein the account profile includes data related to a single transaction account associated with a plurality of consumers including at least a plurality of transaction data entries, each transaction data entry including transaction data related to a payment transaction involving the single transaction account and being associated with one of the plurality of associated consumers; receiving, by a receiving device, a transaction request, wherein the transaction request specifies one or more transaction data entries included in the account profile; transmitting, by a transmitting device, the specified one or more transaction data entries in response to the received transaction request; receiving, by the receiving device, an updated consumer association for a specific transaction data entry of the specified one or more transaction data entries; and updating, in the account profile, the consumer associated with the specific transaction data entry to a different consumer of the plurality of associated consumers based on the received updated consumer association.

A system for providing transparency for gathered purchase data includes an account database, a receiving device, a processing device, and a transmitting device. The account database is configured to store a plurality of account profiles, wherein each account profile includes data related to a transaction account associated with a consumer including at least an account identifier and a plurality of consumer data entries, each consumer data entry including data associated with the associated consumer including a data value and at least one of: source data, use data, and permission data. The receiving device is configured to receive a data request, wherein the data request includes at least a specific account identifier and one or more requested consumer data entries. The processing device is configured to: identify, in the account database, a specific account profile where the included account identifier corresponds to the specific account identifier; and identify, in the specific account profile, one or more consumer data entries of the plurality of consumer data entries corresponding to the one or more requested consumer data entries. The transmitting device is configured to transmit at least the data value included in each of the identified one or more consumer data entries. The data value included in each consumer data entry is based on one or more payment transactions or use of a payment card associated with the related transaction account.

A system for updating gathered purchase data includes a processing device, an account database, a receiving device, and a transmitting device. The account database is configured to store an account profile, wherein the account profile includes data related to a single transaction account associated with a plurality of consumers including at least a plurality of transaction data entries, each transaction data entry including transaction data related to a payment transaction involving the single transaction account and being associated with one of the plurality of associated consumers. The receiving device is configured to receive a transaction request, wherein the transaction request specifies one or more transaction data entries included in the account profile. The transmitting device is configured to transmit the specified one or more transaction data entries in response to the received transaction request. The receiving device is further configured to receive an updated consumer association for a specific transaction data entry of the specified one or more transaction data entries. The processing device is configured to update, in the account profile, the consumer associated with the specific transaction data entry to a different consumer of the plurality of associated consumers based on the received updated consumer association.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for providing transparency to a consumer for gathered purchase data in accordance with exemplary embodiments.

FIG. 2 is a block diagram illustrating the processing server of FIG. 1 for providing transparency and management of gathered purchase data in accordance with exemplary embodiments.

FIG. 3 is a block diagram illustrating the account database of FIG. 2 for storing account profiles of gathered purchase data in accordance with exemplary embodiments.

FIG. 4 is a flow diagram illustrating a process for providing access to gathered purchase data to a consumer using the system of FIG. 1 in accordance with exemplary embodiments.

FIG. 5 is a flow diagram illustrating a process for updating gathered purchase data by a consumer using the system of FIG. 1 in accordance with exemplary embodiments.

FIGS. 6A-6C illustrate a graphical user interface for the viewing and management of gathered purchase data in accordance with exemplary embodiments.

FIG. 7 is a flow chart illustrating an exemplary method for providing transparency for gathered purchase data in accordance with exemplary embodiments.

FIG. 8 is a flow chart illustrating an exemplary method for updating gathered purchase data in accordance with exemplary embodiments.

FIG. 9 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Payment Card—A card or data associated with a transaction account that may be provided to a merchant in order to fund a financial transaction via the associated transaction account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated transaction account (e.g., as stored in a communication device, such as a smart phone or computer). For example, in some instances, data including a payment account number may be considered a payment card for the processing of a transaction funded by the associated transaction account. In some instances, a check may be considered a payment card where applicable.

### System for Providing Transparency and Management of Gathered Purchase Data

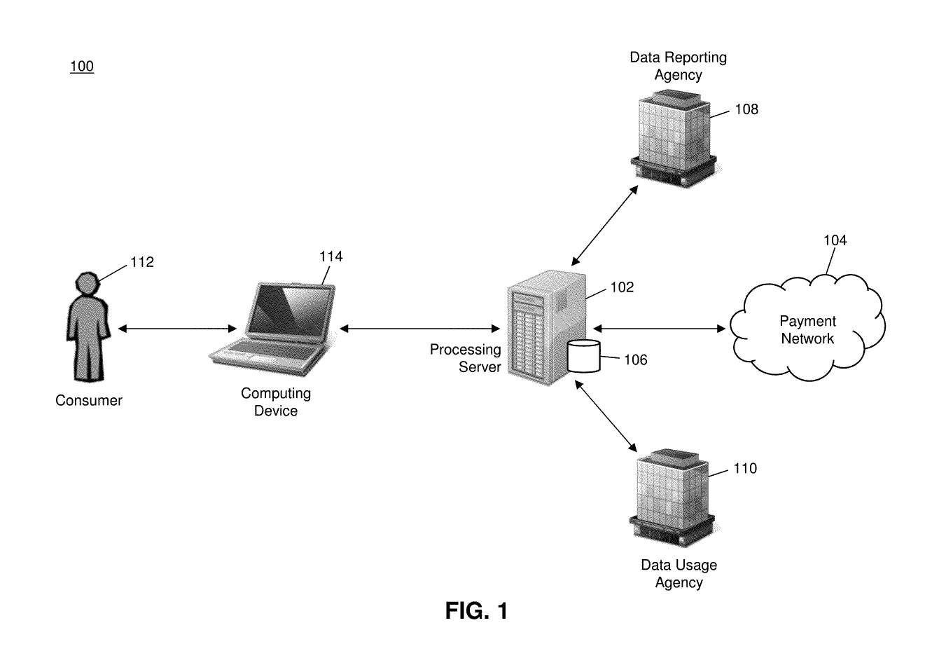

FIG. 1 illustrates a system 100 for the providing of transparency and management of purchase data gathered on a consumer.

The system 100 may include a processing server 102. The processing server 102, discussed in more detail below, may be configured to gather purchase data for consumers and provide transparency and management of the gathered purchase data to the consumers. The processing server 102 may gather purchase data from one or more payment networks 104. The payment networks 104 may collect purchase data during the processing of payment transactions using methods and systems that will be apparent to persons having skill in the relevant art. The gathered purchase data may include transaction data (e.g., transaction amounts, transaction time and/or dates, geographic location, etc.), merchant data, product data, etc. The purchase data may be transmitted to the processing server 102 and stored in an account database 106, discussed in more detail below. In some embodiments, the processing server 102 may be a part of the payment network 104.

The processing server 102 may also receive data from one or more data reporting agencies 108. The data reporting agencies 108 may be any type of entity that collects data on consumers for reporting to third parties, such as a credit bureau. The data reporting agencies 108 may collect consumer data using methods and systems that will be apparent to persons having skill in the relevant art, and may provide the data to the processing server 102. The processing server 102 may store the consumer data in the account database 106 with the collected purchase data. In some embodiments, the consumer data may be based on the payment transactions involving the related consumer, use of a payment card associated with the related consumer, and/or a transaction account associated with the related consumer. In some instances, the processing server 102 may be a data reporting agency 108.

The processing server 102 may also be configured to receive data regarding how a consumer's data is used by one or more data usage agencies 110. The data usage agencies 110 may be entities that use the data gathered on consumers, such as advertisers, content providers, merchants, deal providers, retailers, etc. The processing server 102 may receive data usage information from the data usage agencies 110 and may associate the usage information with the used data stored in the account database 106. In some instances, the processing server 102 may be a data usage agency 110.

The processing server 102 may provide transparency of the gathered consumers and purchase data and its usage to the associated consumer 112. The consumer 112 may view the data using a computing device 114. The computing device 114 may be a desktop computer, laptop computer, notebook computer, tablet computer, smart phone, cellular phone, smart watch, smart television, or any other type of computing device suitable for performing the functions disclosed herein as will be apparent to persons having skill in the relevant art.

The consumer 112 may request to view some or all of the data gathered on the consumer 112 using the computing device 114. The request may be submitted via an application program specifically programmed for viewing and managing consumer data, a web browsing application program for viewing and managing the consumer data via a web page, or other suitable method. The processing server 102 may receive the request and may provide the data for viewing and management by the consumer 112, as discussed in more detail below.

The consumer 112 may then view data that has been gathered on them, and may perform management of the data. Management of the data may include deleting gathered data, placing restrictions on the use of gathered data, modifying the present or future usage of gathered data, and additional functions that will be apparent to persons having skill in the relevant art. Management functions initiated by the consumer 112 (e.g., via the computing device 114) may be transmitted to the processing server 102 and the corresponding action performed, as discussed in more detail below.

In some embodiments, multiple consumers 112 may have access to a single account, such as a single transaction account for which data has been gathered by the processing server 102. In such an embodiment, one of the consumers 112 may be able to update data gathered for the single account to indicate which of the consumers 112 that have access to the account the data should be associated with. For example, if a consumer 112 and their spouse both share a transaction account, the processing server 102 may gather data regarding transactions conducted using the account and may attempt to associate each transaction with either the consumer 112 or their spouse using methods and systems that will be apparent to persons having skill in the relevant art. In some embodiments, management of the gathered data may include managing the associations of transaction data or other gathered data to one of the consumers 112 associated with the account, such as by changing the consumer associated with a transaction. In some instances, the processing server 102 may be configured to update stored data values based on the changed consumer association.

By gathering information regarding gathered consumer data and its usage, the processing server 102 may be able to provide the consumer 112 with transparency regarding their personal data. In addition, by providing the ability to manage usage and permissions to access and store their personal data, consumers 112 may have even more freedom regarding their data and may not only have transparency, but may also have added security as well.

### Processing Server

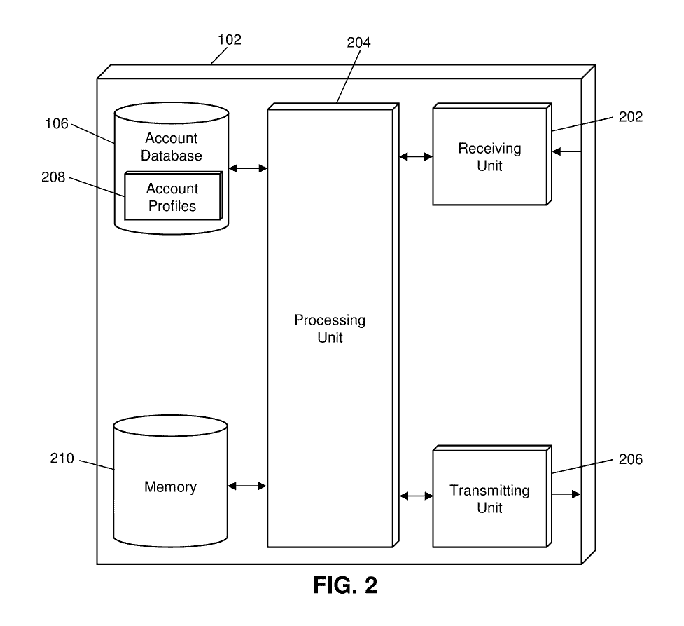

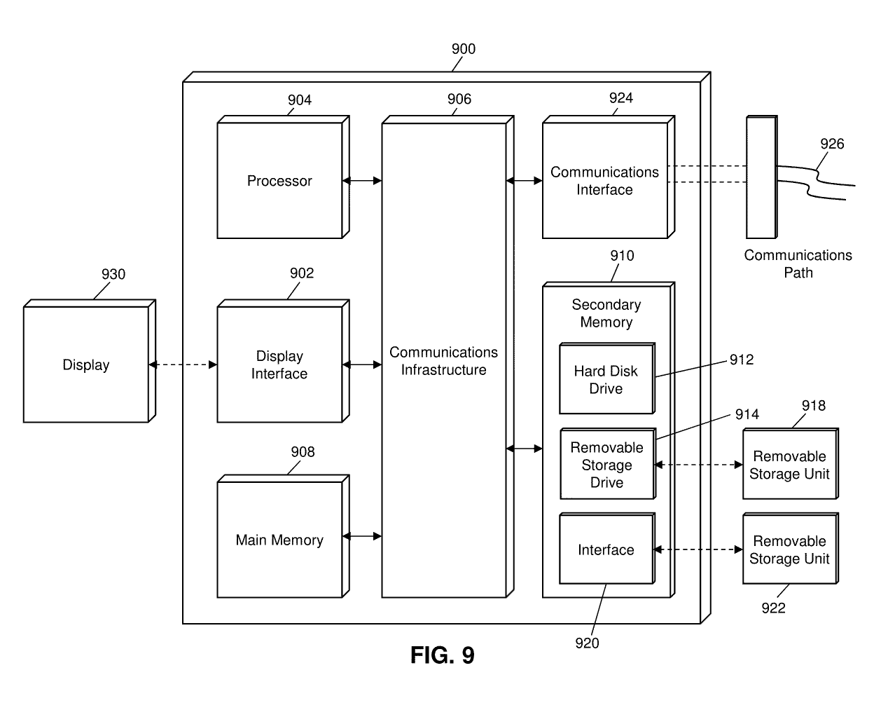

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 900 illustrated in FIG. 9 and discussed in more detail below may be a suitable configuration of the processing server 102.

The processing server 102 may include the account database 106. The account database 106, as discussed in more detail below, may be configured to store a plurality of account profiles 208. Each account profile 208 may include data related to a consumer 112 including a plurality of consumer data entries configured to store data associated with the related consumer 112.

The processing server 102 may also include a receiving unit 202. The receiving unit 202 may be configured to receive data over one or more networks via one or more network protocols. The receiving unit 202 may receive the consumer data to be stored in the account database 106, including data values, usage data, source data, permission data, and any other suitable type of data regarding consumers 112. The receiving unit 202 may also be configured to receive data requests and data update requests, such as from the computing device 114. Received data request and data update requests may specify an account profile 208 for which data is requested or to be updated, such as by specifying an identification value for the account profile 208, as discussed in more detail below.

The processing server 102 may further include a processing unit 204. The processing unit 204 may be configured to perform the functions of the processing server 102 discussed herein as will be apparent to persons having skill in the relevant art. The processing unit 204 may identify account profiles 208 for which data is requested or to be updated, such as specified in a received data request or data update request. The processing unit 204 may also be configured to identify requested data stored in an identified account profile 208 and to update specified data in an identified account profile 208 based on information in a received data update request.

In some embodiments, the processing unit 204 may be configured to calculate consumer data values. For instance, if a data update request is a request to update a consumer 112 associated with one or more payment transactions in an account profile 208, such as for a shared account, the processing unit 204 may update the consumer association for the payment transactions and may then calculate new consumer data values as a result of the changed association, such as calculating new purchase behaviors for each consumer 112 on the account.

The processing server 102 may also include a transmitting unit 206. The transmitting unit 206 may be configured to transmit data over one or more networks via one or more network protocols. The transmitting unit 206 may transmit identified consumer data to consumers 112 via the computing devices 114. The transmitting unit 206 may also transmit notifications to a consumer 112 via their computing device 114, such as a notification regarding success or failure for updating permissions or usage of personal data, updating consumer associations for transactions, updating data values, etc. The transmitting unit 206 may also be configured to transmit notifications to a consumer 112 when their personal data has been update by a third party, such as new data being received, when a new use of their data occurs, when a new request for the data is received, etc.

The processing server 102 may further include a memory 210. The memory 210 may be configured to store data suitable for performing the functions disclosed herein as will be apparent to persons having skill in the relevant art. For example, the memory 210 may be configured to store rules and algorithms regarding the calculation of consumer data values, such as purchase behavior, program code for the execution of functions by the processing unit 204, etc.

### Account Database

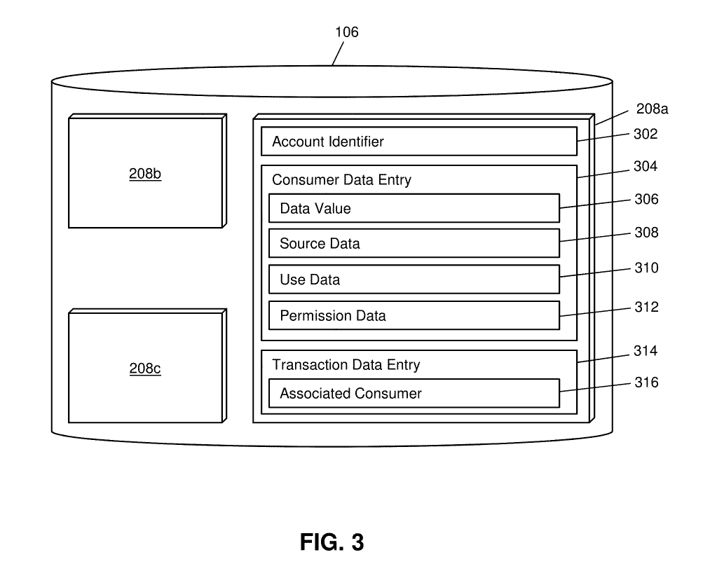

FIG. 3 illustrates an embodiment of the account database 106 of the processing server 102 for the storage of account profiles 208.

As illustrated in FIG. 3, the account database 106 may store a plurality of account profiles 208, illustrated as account profiles 208a, 208b, and 208c. Each account profile 208 may include data related to a transaction account associated with one or more consumers 112 and include an account identifier 302 and a plurality of consumer data entries 304. In some embodiments, an account profile 208 may also include one or more transaction data entries 314. The account identifier 302 may be a unique value suitable for identification of the account profile 208 and/or related transaction account, such as an identification number, registration number, transaction account number, username, e-mail address, telephone number, device identifier (e.g., associated with the computing device 114), or other suitable value that will be apparent to persons having skill in the relevant art.

Each consumer data entry 304 may include data associated with a consumer 112 associated with the related transaction account and may include a data value 306 and one or more of: source data 308, use data 310, and permission data 312. Each consumer data entry 304 may correspond to a piece of consumer data that has been gathered, calculated, inferred, etc. for the related transaction account and/or an associated consumer 112. For instance, a consumer data entry 304 may correspond to a consumer's 112 purchase behavior (e.g., spend propensity for one of a plurality of categories), demographic characteristics (e.g., age, gender, income, residential status, marital status, familial status, zip code, postal code, occupation, education, etc.), etc. The data value 306 may be the actual value for the respective consumer data entry 304. For instance, if a consumer data entry 304 corresponds to a consumer's 112 propensity to spend on electronics, the data value 306 may be the consumer's 112 identified propensity, such as a high propensity to spend, a value of 95 (e.g., out of 100), or other suitable value.

The source data 308 may be data regarding how the data value 306 in the consumer data entry 304 was obtained. For example, if the data value 306 is a propensity to spend on electronics, the source data 308 may include and/or indicate payment transactions involving the related transaction account that resulted in the corresponding propensity to spend on electronics. In some instances, the source data 308 may also, or alternatively, include a source of the data used to obtain, calculate, or otherwise identify the data value 306. For example, the source data 308 may include the payment network 104 or data reporting agency 108 from whom the propensity to spend on electronics, or data used to calculate the propensity, was obtained.

The use data 310 may be data regarding how the data value 306 in the consumer data entry 304 is used. The use data 310 may include actual uses for the data value 306 and/or may include one or more entities that use the data value 306. In some instances, the use data 310 may include the actual use and corresponding entity for a plurality of uses. For example, the use data 310 may include a plurality of different data usage agencies 110 and data regarding how each of the different data usage agencies 110 is using the respective data value 306.

The permission data 312 may be data regarding the availability of the data value 306 to be used by a third party, such as a data usage agency 110. For instance, the permission data 312 may specify that the data value 306 may be freely used by any third party, may only be used by specific third parties or specific types of third parties (e.g., research firms but not advertising agencies, etc.), may only be used for specific types of uses (e.g., non-commercial uses, etc.), or may require permission from a consumer 112 on the related transaction account or a specific associated consumer 112 prior to the data value 306 being obtained and/or used. In some embodiments, the permission data 312 may be updated by the consumer 112 to modify the permissions on the data.

In some instances, if the permission data 312 is updated, the processing server 102 may be configured to transmit notifications and/or requests to third parties (e.g., data usage agencies 110) for modifications to use of the corresponding data as a result of the updated permission data 312. For example, if the consumer 112 updates the permission data 312 regarding their e-mail address such that their e-mail address may not be used without explicit consent, the transmitting unit 206 may transmit a notification to data usage agencies 110 using the e-mail address that they must refrain from using the e-mail address (e.g., for newsletters, advertisements, etc.) unless explicit consent is obtained from the consumer 112. In such an instance, the consumer 112 may be able to affect widespread usage of their personal data in one action via the processing server 102, without having to contact every data usage agency 110 separately.

In instances where an account profile 208 may include transaction data entries 314, each transaction data entry 314 may include data related to a payment transaction involving the related account and an associated consumer 316. The associated consumer 316 may include data regarding a consumer 112 associated with the related payment transaction. In instances where a transaction account may be shared among multiple consumers 112, the associated consumer 316 may be one of the multiple consumers 112. The processing unit 204 of the processing server 102 may be configured to update the associated consumer 316 for a transaction data entry 314 as requested by one of the multiple consumers 112 on the related transaction account.

In some instances, each consumer data entry 304 may also include an associated consumer, which may be one of the multiple consumers 112. For example, the account profile 208 may include a consumer data entry 304 corresponding to data for both a first consumer 112 on the related transaction account and a spouse. In such an instance, the processing unit 204 may be configured to update the corresponding data value 306, if applicable, when the associated consumer 316 for a transaction data entry 314 that is related to the data value 306 is updated. For example, if the data value 306 represents an individual consumer's 112 propensity to spend on electronics, and a transaction data entry 314 for a purchase of electronics is update, the data value 306 may be updated to show a higher propensity for a consumer 112 who is changed to be the associated consumer 316 for the transaction, and to show a lower propensity for a different consumer 112 who is removed as being the associated consumer 316 for the transaction.

### Process for Accessing Gathered Consumer Data

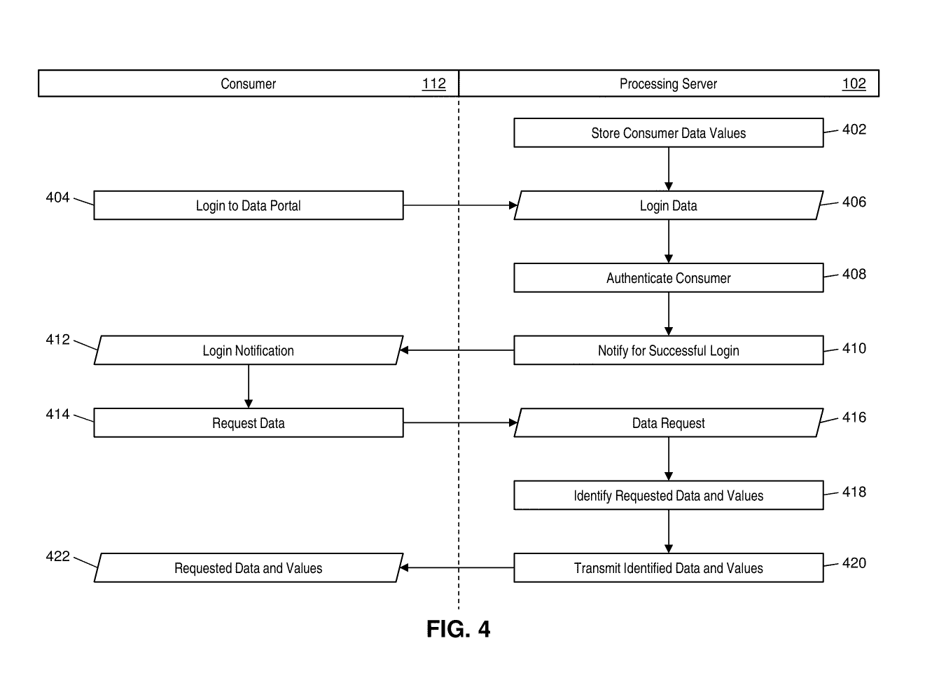

FIG. 4 illustrates a process for providing access to a consumer 112 to their gathered personal data.

In step 402, the processing unit 204 of the processing server 102 may store consumer data values 306 in consumer data entries 304 in account profiles 208 of the account database 106, as discussed above. In step 404, the consumer 112 may login to a portal (e.g., via a web browser, a dedicated application program, etc.), using the computing device 114, such as by providing authentication credentials. In step 406, the receiving unit 202 of the processing server 102 may receive the login data, which may include at least an account identifier.

In step 408, the processing unit 204 may authenticate the consumer 112 by authentication of the provided authentication credentials. Authentication may include identifying an account profile 208 stored in the account database 106 that includes an account identifier 302 corresponding to the account identifier included in the received login data, and comparing the authentication credentials included in the login data with other data included in the identified account profile 208. Additional steps and methods regarding authentication of a user for login to a system will be apparent to persons having skill in the relevant art.

In step 410, the transmitting unit 206 of the processing server 102 may transmit a notification to the computing device 114 of the consumer 112 that indicates the login for access to their account profile 208 is successful. In step 412, the computing device 114 may receive the notification, and may display a notification to the consumer 112 that the login was successful. In step 414, the consumer 112 may submit a request for data to the processing server 102 via the computing device 114, which may be received by the receiving unit 202 in step 416. The request for data may indicate one or more consumer data entries 304 for which data is requested, and, in some instances, may specify a type of data requested for each respective consumer data entry 304, such as the data value 306, source data 308, use data 310, and permission data 312.

In step 418, the processing unit 204 may identify the indicated one or more consumer data entries 304, and, if applicable, may identify the data value 306, source data 308, use data 310, and/or permission data 312 included therein as indicated in the received request for data. In step 420, the transmitting unit 206 may transmit the identified data to the computing device 114 in response to the received request for data. The computing device 114 may receive the requested data, in step 422, and display the data to the consumer 112, such that the consumer 112 may view their gathered personal data and usage and permissions thereof.

### Process for Updating Gathered Personal Data

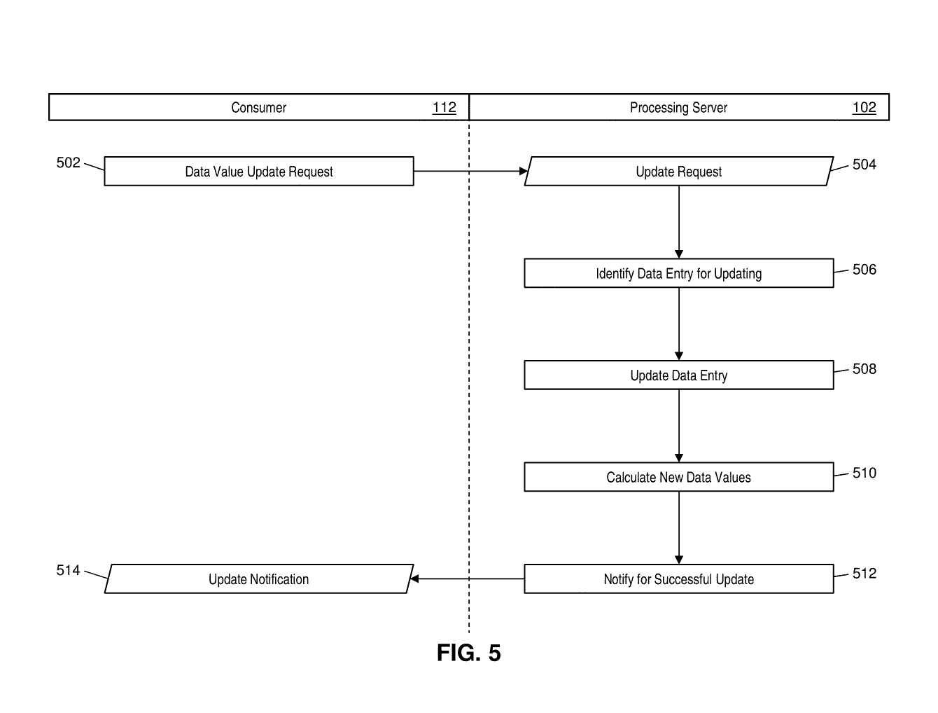

FIG. 5 illustrates a process for the updating of gathered personal data by the consumer 112.

In step 502, the consumer 112 may submit a request (e.g., using the computing device 114) to update one or more pieces of data of one or more consumer data entries 304 to the processing server 102. In step 504, the receiving unit 202 of the processing server 102 may receive the request. The request may include the one or more consumer data entries 304 whose data is to be updated, and may include the updated value for one or more of the included data value 306, source data 308, use data 310, and permission data 312. In some instances, the request may include a request to delete a consumer data entry 304 from the account profile 208.

In step 506, the processing unit 204 of the processing server 102 may identify the account profile 208 for which data is to be updated and may identify the one or more consumer data entries 306 included therein that are to be updated. In step 508, the processing unit 204 may update the data value 306, source data 308, use data 310, and/or permission data 312 as applicable based on the information received in the data update request. In embodiments where the data update request may be to update consumer associations, step 506 may include identifying a corresponding transaction data entry 314 to be updated, and step 508 may include updating the associated consumer 316 included in the transaction data entry 314.

In step 510, the processing unit 204 may update one or more data values 306 as necessary based on the updated data. For instance, if the associated consumer 316 for one or more transaction data entries 314 is updated, data values 306 for the previous associated consumer 316 and the updated associated consumer 316 that are affected by the change may be updated. In another example, if the source data 308 for a consumer data entry 304 is updated, the data value 306 may be updated accordingly due to the removal or addition of data used for the basis of the data value 306.

In step 512, the transmitting unit 206 of the processing server 102 may transmit a notification to the computing device 114 of the consumer 102 that indicates that the data was updated successfully. In step 514, the computing device 114 may receive the notification, which may displayed to the consumer 112 using methods and systems that will be apparent to persons having skill in the relevant art.

In some embodiments, the process may further include the transmitting unit 206 transmitting a notification to one or more data usage agencies 110 regarding usage of the consumer's 112 data. For example, if the permission data 312 for a consumer data entry 304 is updated, the processing server 102 may transmit a notification to a data usage agency 110 whose permission to use the corresponding data value 306 was affected to modify or stop their use of the data accordingly.

### Graphical User Interface

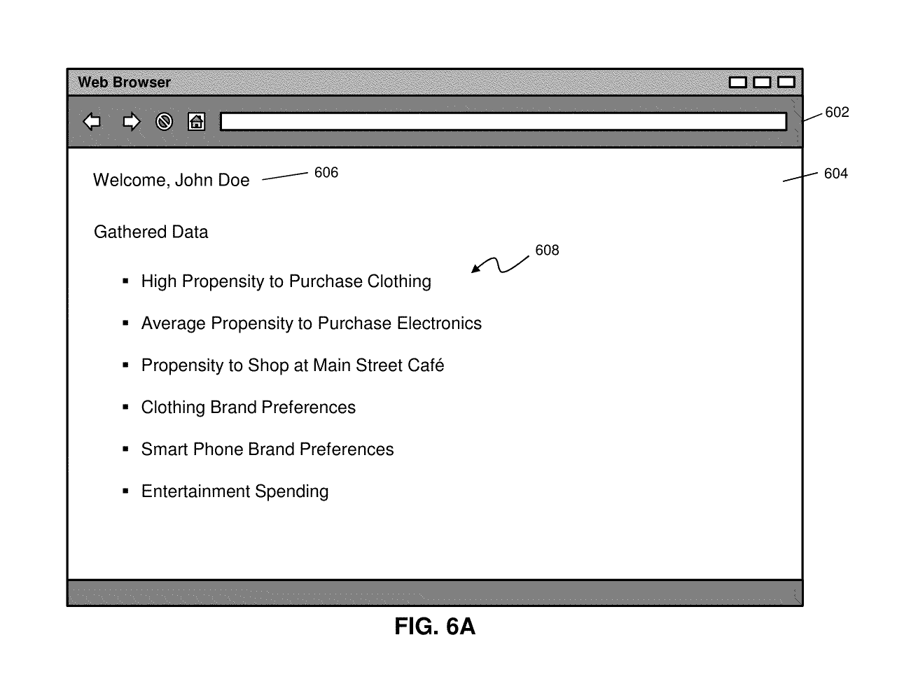

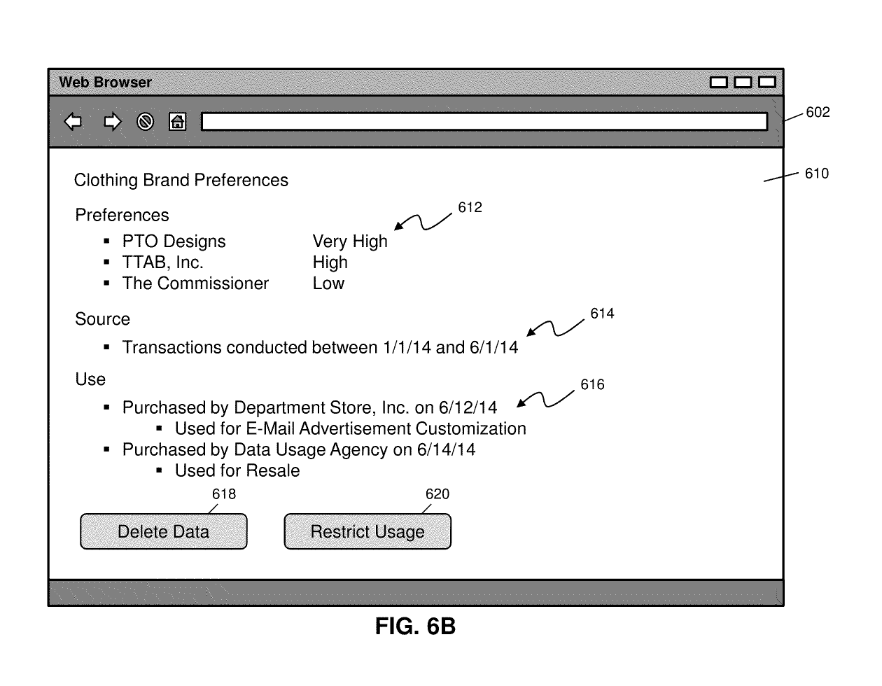

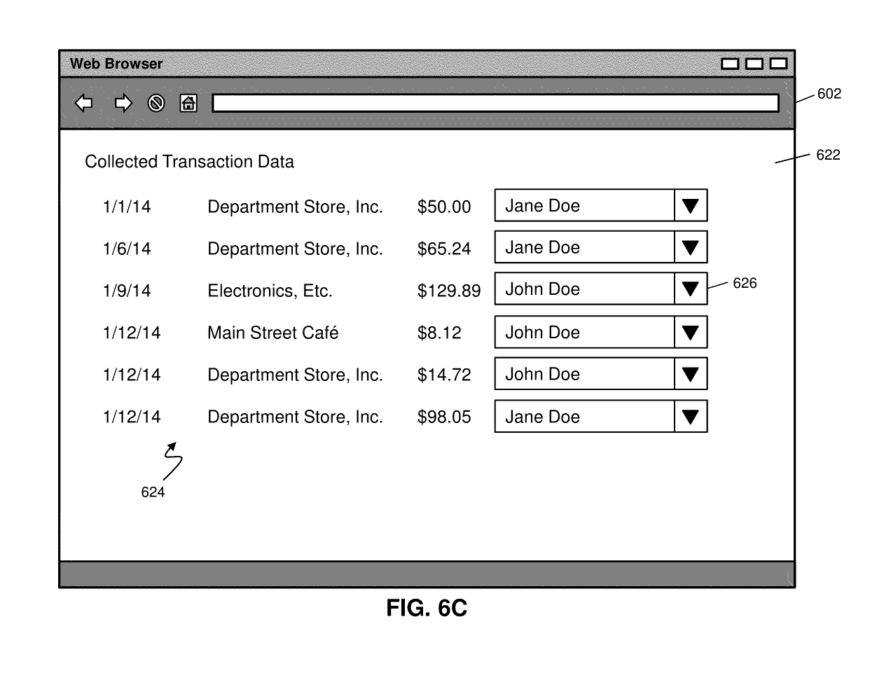

FIGS. 6A-6C illustrate an example graphical user interface of the computing device 114 for providing access to and management of a consumer's 112 personal data using the methods and systems discussed herein. It will be apparent to persons having skill in the relevant art that the interfaces illustrated in FIGS. 6A-6C and discussed herein are provided as illustrations only, and that interfaces suitable for implementing the methods and systems disclosed herein may include additional and/or alternative components and configurations.

As illustrated in FIG. 6A, the consumer 112 may use a web browsing application program 602 via the computing device 114 to access their personal data via a web page 604. The web page 604 may display a name 606, which may indicate to the consumer 112 that they are logged in and viewing their own personal data. The web page 604 may also include a plurality of data fields 608. Each data field 608 may correspond to a consumer data entry 304 in an account profile 208 associated with the consumer 102 and/or a data value 306 included therein.

In some instances, the web page 604 may display all of the data gathered for a consumer 112. In other embodiments, the consumer 112 may specifically request data fields 306 to be viewed. For example, in the example illustrated in FIG. 6A, John Doe, the consumer 112, may have requested to view personal data gathered regarding his purchase behaviors, which include his shopping preferences and his propensity to spend in specific categories or industries.

The consumer 112 may select one of the data fields 608 in order to view more detail about the corresponding consumer data entry 304. For instance, John Doe may select the clothing brand preferences data field 608 and be presented with a detailed view web page 610, illustrated in FIG. 6B. The detailed view web page 610 may displayed detailed data regarding his clothing brand preferences.

The detailed view web page 610 may include the data values 306 included in the corresponding consumer data entry 304, illustrated as preferences 612 in FIG. 6B. The detailed view web page 610 may also include source information 614, which may corresponding to the source data 308 included in the corresponding consumer data entry 304, and use information 616, which may correspond to the use data 310 included in the corresponding consumer data entry 304. As illustrated in FIG. 6B, the use information 616 may include both the data usage agencies 110 using the data, and how the data is used.

The detailed view web page 610 may also include a delete data button 618. The delete data button 618, when interacted with by the consumer 112, may delete the consumer data entry 304 from the account profile 208, such that the corresponding data will not be gathered and may not be used by third parties. The detailed view web page 610 may additionally include a restrict usage button 620. The restrict usage button 620, when interacted with by the consumer 112, may present the consumer 112 with options for updating the permission data 312 for updating permissions regarding usage of the data.

FIG. 6C illustrates an association update web page 622. The association update web page 622 may be used by the consumer 112 to update the consumer that is associated with transaction data entries 314 included in an account profile 208 that the consumer 112 shares with one or more other consumers. The association update web page 622 may include a plurality of transactions 624. Each transaction 624 may correspond to a transaction data entry 314 in the account profile 208. Each transaction 624 may also have a consumer field 626.

The consumer field 626 may display a consumer 112 corresponding to the associated consumer 316 in the corresponding transaction data entry 314. The consumer 112 accessing the association update web page 622 may change the consumer 112 included in the consumer field 626 to update the corresponding associated consumer 316 in the transaction data entry 314.

### Exemplary Method for Providing Transparency for Gathered Purchase Data

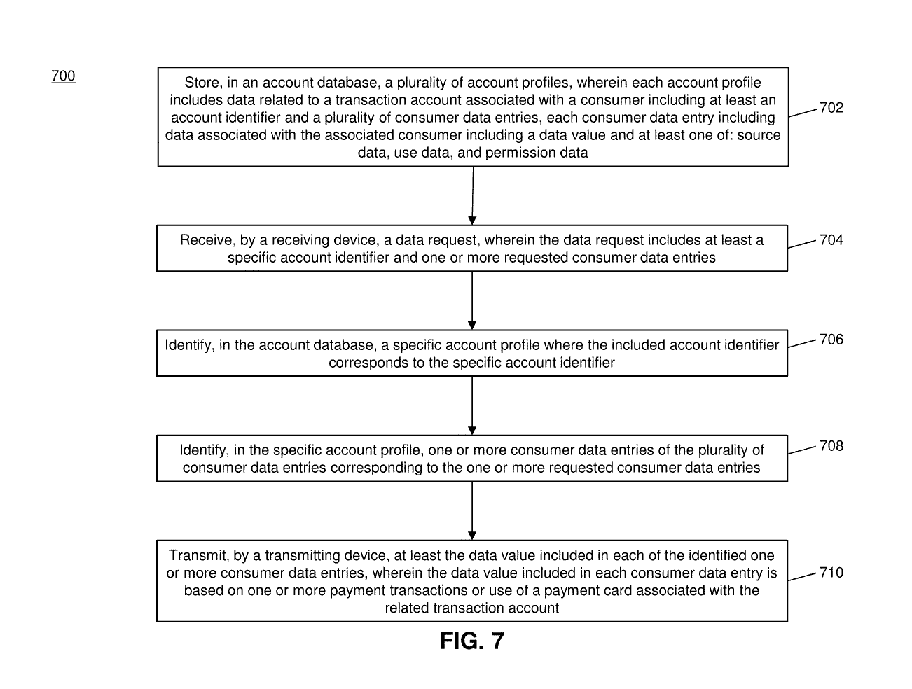

FIG. 7 illustrates a method 700 for the providing of transparency to a consumer for purchase data gathered on the consumer.

In step 702, a plurality of account profiles (e.g., account profiles 208) may be stored in an account database (e.g., the account database 106), wherein each account profile 208 includes data related to a transaction account associated with a consumer (e.g., the consumer 112) including at least an account identifier (e.g., the account identifier 302) and a plurality of consumer data entries (e.g., consumer data entries 304), each consumer data entry 304 including data associated with the associated consumer 112 including a data value (e.g., the data value 306) and at least one of: source data (e.g., the source data 308), use data (e.g., the use data 310), and permission data (e.g., the permission data 312).

In step 704, a data request may be received by a receiving device (e.g., the receiving unit 202), wherein the data request includes at least a specific account identifier and one or more requested consumer data entries. In step 706, a specific account profile 208 may be identified in the account database 106 where the included account identifier 302 corresponds to the specific account identifier. In step 708, one or more consumer data entries 304 of the plurality of consumer data entries 304 in the specific account profile 208 may be identified corresponding to the one or more requested consumer data entries.

In step 710, at least the data value 306 included in each of the identified one or more consumer data entries 304 may be transmitted by a transmitting device (e.g., the transmitting unit 206), wherein the data value included in each consumer data entry 304 is based on one or more payment transactions or use of a payment card associated with the related transaction account. In some embodiments, each consumer data entry 304 may include at least two of: source data 308, use data 310, and permission data 312. In a further embodiment, the data request may further include a data type for each of the one or more requested consumer data entries, and the transmitting step may further include transmitting source data 308, use data 310, or permission data 312 corresponding to the data type included in the data request for each consumer data entry 304 of the identified one or more consumer data entries.

In one embodiment, the method 700 may further include: receiving, by the receiving device 202, a corrected data value corresponding to an incorrect consumer data entry of the identified one or more consumer data entries 304; and updating, in the specific account profile 208, the data value 306 included in the incorrect data entry based on the received corrected data value. In some embodiments, the method 700 may also include: receiving, by the receiving device 202, a deletion request, wherein the deletion request specifics at least one of the identified one or more consumer data entries 304 for deletion; and deleting, in the specific account profile 208, the specified at least one of the identified one or more consumer data entries 304.

In one embodiment, the method 700 may further include: receiving, by the receiving device 202, updated permission data corresponding to a specific consumer data entry 304 of the identified one or more consumer data entries; and updating, in the specific account profile 208, the permission data 312 included in the specific consumer data entry 304 based on the received updated permission data.

### Exemplary Method for Updating Gathered Purchase Data

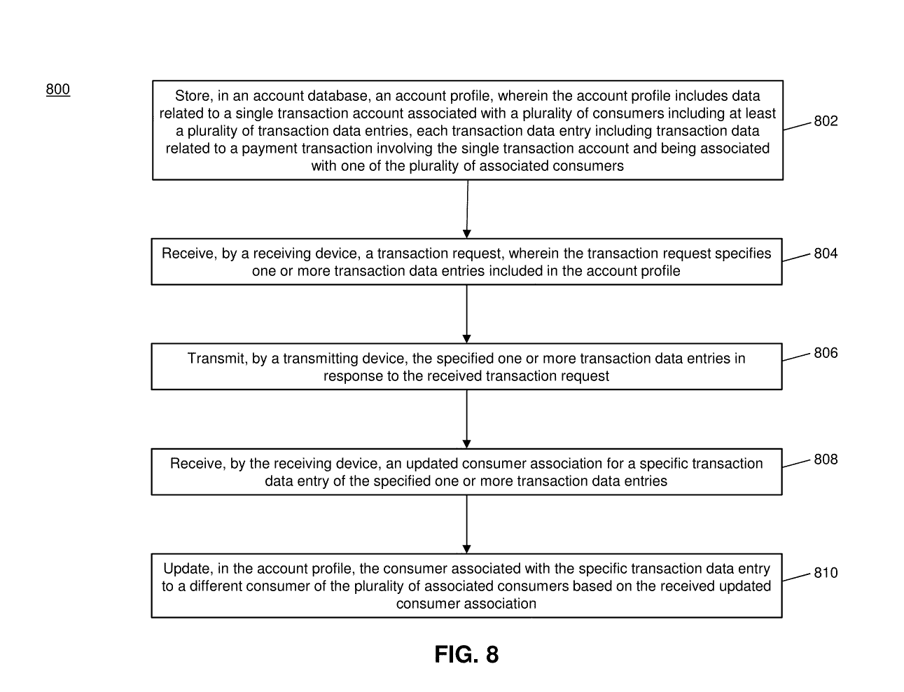

FIG. 8 illustrates a method 800 for updating consumer associations of gathered purchase data by a consumer.

In step 802, an account profile (e.g., an account profile 208) may be stored in an account database (e.g., the account database 106), wherein the account profile 208 includes data related to a single transaction account associated with a plurality of consumers (e.g., consumers 112) including at least a plurality of transaction data entries (e.g., transaction data entries 314), each transaction data entry 314 including transaction data related to a payment transaction involving the single transaction account and being associated with one of the plurality of associated consumers. In one embodiment, each transaction data entry 314 may further include at least one of: source data, use data, and permission data.

In step 804, a transaction request may be received by a receiving device (e.g., the receiving unit 202), wherein the transaction request specified one or more transaction data entries 314 included in the account profile 208. In step 806, the specified one or more transaction data entries 314 may be transmitted, by a transmitting device (e.g., the transmitting unit 206), in response to the received transaction request.

In step 808, an updated consumer association may be received, by the receiving device 202, for a specific transaction data entry 314 of the specified one or more transaction data entries 314. In step 810, the consumer 112 associated with the specific transaction data entry 314 may be updated, in the account profile 208, to a different consumer 112 of the plurality of associated consumers based on the received updated consumer association.

In one embodiment, the account profile 208 may further include a plurality of consumer data entries (e.g., consumer data entries 304), wherein each consumer data entry 304 may include data associated with one of the plurality of associated consumers 112 including a data value (e.g., data value 306) and at least one of: source data (e.g., source data 308), use data (e.g., use data 310), and permission data (e.g., permission data 312). In a further embodiment, the method 800 may further include updating, in the account profile 208, the data value 306 included in one or more consumer data entries 304 associated with the different consumer 112 of the plurality of associated consumers based on the updated specific transaction data entry 314. In another further embodiment, the method 800 may further include updating, in the account profile 208, the data value 306 included in one or more consumer data entries 314 associated with the consumer 112 associated with the specific transaction data entry 314 prior to updating based on the updated specific transaction data entry 314.

### Computer System Architecture

FIG. 9 illustrates a computer system 900 in which embodiments of the present disclosure, or portions thereof, may be implemented as computer-readable code. For example, the processing server 102 of FIG. 1 may be implemented in the computer system 900 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4, 5, 7, and 8.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 918, a removable storage unit 922, and a hard disk installed in hard disk drive 912.

Various embodiments of the present disclosure are described in terms of this example computer system 900. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 904 may be a special purpose or a general purpose processor device. The processor device 904 may be connected to a communications infrastructure 906, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 900 may also include a main memory 908 (e.g., random access memory, read-only memory, etc.), and may also include a secondary memory 910. The secondary memory 910 may include the hard disk drive 912 and a removable storage drive 914, such as a floppy disk drive, a magnetic tape drive, an optical disk drive, a flash memory, etc.

The removable storage drive 914 may read from and/or write to the removable storage unit 918 in a well-known manner. The removable storage unit 918 may include a removable storage media that may be read by and written to by the removable storage drive 914. For example, if the removable storage drive 914 is a floppy disk drive or universal serial bus port, the removable storage unit 918 may be a floppy disk or portable flash drive, respectively. In one embodiment, the removable storage unit 918 may be non-transitory computer readable recording media.

In some embodiments, the secondary memory 910 may include alternative means for allowing computer programs or other instructions to be loaded into the computer system 900, for example, the removable storage unit 922 and an interface 920. Examples of such means may include a program cartridge and cartridge interface (e.g., as found in video game systems), a removable memory chip (e.g., EEPROM, PROM, etc.) and associated socket, and other removable storage units 922 and interfaces 920 as will be apparent to persons having skill in the relevant art.

Data stored in the computer system 900 (e.g., in the main memory 908 and/or the secondary memory 910) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 900 may also include a communications interface 924. The communications interface 924 may be configured to allow software and data to be transferred between the computer system 900 and external devices. Exemplary communications interfaces 924 may include a modem, a network interface (e.g., an Ethernet card), a communications port, a PCMCIA slot and card, etc. Software and data transferred via the communications interface 924 may be in the form of signals, which may be electronic, electromagnetic, optical, or other signals as will be apparent to persons having skill in the relevant art. The signals may travel via a communications path 926, which may be configured to carry the signals and may be implemented using wire, cable, fiber optics, a phone line, a cellular phone link, a radio frequency link, etc.

The computer system 900 may further include a display interface 902. The display interface 902 may be configured to allow data to be transferred between the computer system 900 and external display 930. Exemplary display interfaces 902 may include high-definition multimedia interface (HDMI), digital visual interface (DVI), video graphics array (VGA), etc. The display 930 may be any suitable type of display for displaying data transmitted via the display interface 902 of the computer system 900, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 908 and secondary memory 910, which may be memory semiconductors (e.g., DRAMs, etc.). These computer program products may be means for providing software to the computer system 900. Computer programs (e.g., computer control logic) may be stored in the main memory 908 and/or the secondary memory 910. Computer programs may also be received via the communications interface 924. Such computer programs, when executed, may enable computer system 900 to implement the present methods as discussed herein. In particular, the computer programs, when executed, may enable processor device 904 to implement the methods illustrated by FIGS. 4, 5, 7, and 8, as discussed herein. Accordingly, such computer programs may represent controllers of the computer system 900. Where the present disclosure is implemented using software, the software may be stored in a computer program product and loaded into the computer system 900 using the removable storage drive 914, interface 920, and hard disk drive 912, or communications interface 924.

Techniques consistent with the present disclosure provide, among other features, systems and methods for providing transparency for gathered purchase data and updating gathered purchase data. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for providing transparency for gathered purchase data, comprising:
storing, in an account database, a plurality of account profiles, wherein each account profile includes data related to a transaction account associated with a consumer including at least an account identifier and a plurality of consumer data entries, each consumer data entry including data associated with the associated consumer including a data value and at least one of: source data, use data, and permission data;
receiving, by a receiving device, a data request, wherein the data request includes at least a specific account identifier and one or more requested consumer data entries;
identifying, in the account database, a specific account profile where the included account identifier corresponds to the specific account identifier;
identifying, in the specific account profile, one or more consumer data entries of the plurality of consumer data entries corresponding to the one or more requested consumer data entries; and
transmitting, by a transmitting device, at least the data value included in each of the identified one or more consumer data entries, wherein
the data value included in each consumer data entry is based on one or more payment transactions or use of a payment card associated with the related transaction account.

2. The method of claim 1, further comprising:
receiving, by the receiving device, a corrected data value corresponding to an incorrect consumer data entry of the identified one or more consumer data entries; and
updating, in the specific account profile, the data value included in the incorrect consumer data entry based on the received corrected data value.

3. The method of claim 1, further comprising:
receiving, by the receiving device, a deletion request, wherein the deletion request specifies at least one of the identified one or more consumer data entries for deletion; and
deleting, in the specific account profile, the specified at least one of the identified one or more consumer data entries.

4. The method of claim 1, further comprising:
receiving, by the receiving device, updated permission data corresponding to a specific consumer data entry of the identified one or more consumer data entries; and
updating, in the specific account profile, the permission data included in the specific consumer data entry based on the received updated permission data.

5. The method of claim 1, wherein
each consumer data entry includes at least two of: source data, use data, and permission data,
the data request further includes a data type for each of the one or more requested consumer data entries, and
the transmitting step further includes transmitting source data, use data, or permission data corresponding to the data type included in the data request for each consumer data entry of the identified one or more consumer data entries.

6. A method for updating gathered purchase data, comprising:
storing, in an account database, an account profile, wherein the account profile includes data related to a single transaction account associated with a plurality of consumers including at least a plurality of transaction data entries, each transaction data entry including transaction data related to a payment transaction involving the single transaction account and being associated with one of the plurality of associated consumers;
receiving, by a receiving device, a transaction request, wherein the transaction request specifies one or more transaction data entries included in the account profile;
transmitting, by a transmitting device, the specified one or more transaction data entries in response to the received transaction request;
receiving, by the receiving device, an updated consumer association for a specific transaction data entry of the specified one or more transaction data entries; and
updating, in the account profile, the consumer associated with the specific transaction data entry to a different consumer of the plurality of associated consumers based on the received updated consumer association.

7. The method of claim 6, wherein the account profile further includes a plurality of consumer data entries, wherein each consumer data entry includes data associated with the one of the plurality of associated consumers including a data value and at least one of: source data, use data, and permission data.

8. The method of claim 7, further comprising:
updating, in the account profile, the data value included in one or more consumer data entries associated with the different consumer of the plurality of associated consumers based on the updated specific transaction data entry.

9. The method of claim 7, further comprising:
updating, in the account profile, the data value included in one or more consumer data entries associated with the consumer associated with the specific transaction data entry prior to updating based on the updated specific transaction data entry.

10. The method of claim 6, wherein each transaction data entry further includes at least one of: source data, use data, and permission data.

11. A system for providing transparency for gathered purchase data, comprising:
an account database configured to store a plurality of account profiles, wherein each account profile includes data related to a transaction account associated with a consumer including at least an account identifier and a plurality of consumer data entries, each consumer data entry including data associated with the associated consumer including a data value and at least one of: source data, use data, and permission data;
a receiving device configured to receive a data request, wherein the data request includes at least a specific account identifier and one or more requested consumer data entries;
a processing device configured to
identify, in the account database, a specific account profile where the included account identifier corresponds to the specific account identifier, and
identify, in the specific account profile, one or more consumer data entries of the plurality of consumer data entries corresponding to the one or more requested consumer data entries; and
a transmitting device configured to transmit at least the data value included in each of the identified one or more consumer data entries, wherein
the data value included in each consumer data entry is based on one or more payment transactions or use of a payment card associated with the related transaction account.

12. The system of claim 11, wherein
the receiving device is further configured to receive a corrected data value corresponding to an incorrect consumer data entry of the identified one or more consumer data entries, and
the processing device is further configured to update, in the specific account profile, the data value included in the incorrect consumer data entry based on the received corrected data value.

13. The system of claim 11, wherein
the receiving device is further configured to receive a deletion request, wherein the deletion request specifies at least one of the identified one or more consumer data entries for deletion, and
the processing device is further configured to delete, in the specific account profile, the specified at least one of the identified one or more consumer data entries.

14. The system of claim 11, wherein
the receiving device is further configured to receive updated permission data corresponding to a specific consumer data entry of the identified one or more consumer data entries, and
the processing device is further configured to update, in the specific account profile, the permission data included in the specific consumer data entry based on the received updated permission data.

15. The system of claim 11, wherein
each consumer data entry includes at least two of: source data, use data, and permission data,
the data request further includes a data type for each of the one or more requested consumer data entries, and
the transmitting device is further configured to transmit source data, use data, or permission data corresponding to the data type included in the data request for each consumer data entry of the identified one or more consumer data entries.

16. A system for updating gathered purchase data, comprising:
a processing device;
an account database configured to store an account profile, wherein the account profile includes data related to a single transaction account associated with a plurality of consumers including at least a plurality of transaction data entries, each transaction data entry including transaction data related to a payment transaction involving the single transaction account and being associated with one of the plurality of associated consumers;
a receiving device configured to receive a transaction request, wherein the transaction request specifies one or more transaction data entries included in the account profile; and
a transmitting device configured to transmit the specified one or more transaction data entries in response to the received transaction request, wherein
the receiving device is further configured to receive an updated consumer association for a specific transaction data entry of the specified one or more transaction data entries, and
the processing device is configured to update, in the account profile, the consumer associated with the specific transaction data entry to a different consumer of the plurality of associated consumers based on the received updated consumer association.

17. The system of claim 16, wherein the account profile further includes a plurality of consumer data entries, wherein each consumer data entry includes data associated with the one of the plurality of associated consumers including a data value and at least one of: source data, use data, and permission data.

18. The system of claim 17, wherein the processing device is further configured to update, in the account profile, the data value included in one or more consumer data entries associated with the different consumer of the plurality of associated consumers based on the updated specific transaction data entry.

19. The system of claim 17, wherein the processing device is further configured to update, in the account profile, the data value included in one or more consumer data entries associated with the consumer associated with the specific transaction data entry prior to updating based on the updated specific transaction data entry.

20. The system of claim 16, wherein each transaction data entry further includes at least one of: source data, use data, and permission data.
